(19) United States
(12) Patent Application Publication
(10) Pub. No.: US 2004/0179927 A1
(43) Pub. Date: Sep. 16, 2004

(54) Transfer device for reversibly moving an object in horizontal or inclined translation

(75) Inventor: Jean Georges, Menil Aux Bois (FR)

Correspondence Address: MICHAEL P. MAZZA, LLC, 686 CRESCENT BLVD., GLEN ELYN, IL, 60137, US

(73) Assignee: JIGE INTERNATIONAL (Societe Anonyme)

(21) Appl. No.: 10/706,627

(22) Filed: Nov. 12, 2003

(30) Foreign Application Priority Data
Mar. 14, 2003 (FR) 0303156

(51) Int. Cl. B60P 1/04

(52) U.S. Cl. 414/491

(57) ABSTRACT

A transfer device used on recovery vehicles, having a cylinder for reversibly moving an object, such as a disabled vehicle, in horizontal or inclined translation over a travel distance substantially larger than that of the cylinder.

The present invention relates to a transfer device with a cylinder for reversibly moving an object in horizontal or inclined translation over a travel distance substantially twice as large as that of said cylinder.

There are already known lifting devices with a cylinder, used on lifting trucks, which comprise cable elements such as chains, passing over a pulley arranged at the end of the rod of a cylinder, and which allows, while being driven by the latter, the vertical movement of gripping means such as a fork over a travel distance twice as long as that of said cylinder. These lifting devices can however not be used for a horizontal translation or according to a certain inclination, since only one driving direction is foreseen, the lowering being achieved by gravity.

The invention also relates to a particular application of the transfer device according to the invention in the field of the transport vehicles with a moving platform, of the type including a chassis provided with a platform capable of sliding and tilting to adopt two extreme positions, one unfolded and lowered to the ground allowing proceeding to loading an object or an immobilised vehicle, and the other one raised with respect to said chassis, for the transportation.

In fact, as is known, such a platform is mounted movable in translation onto a ramp the chassis is provided with and which is, in turn, capable of tilting with respect to the latter, like a tub, to pass over from a horizontal position, parallel to said chassis, into an inclined position.

Thus, to load a craft immobilised on the ground onto a vehicle of this type, the operator first proceeds to tilting the ramp with respect to the chassis, before bringing the platform near to the ground, through sliding along the ramp. The object or the immobilised vehicle to be loaded is then pulled onto the platform, and the latter is brought back to the chassis through sliding in the opposite direction along the ramp, which is then tilted in the opposite direction, to be restored into its initial position, parallel to the chassis.

One will easily understand that, in order to make easy the loading, namely depending on the nature of the object or of the vehicle to be loaded, e.g. with a large overhang and/or a small ground clearance, the platform must, on the one hand, rest on the ground and, on the other hand, form, with respect to the latter, an angle as small as possible.

Most devices for controlling the moving of such a platform also comprise means that also allow the latter to perform, after sliding along the ramp, a slight pivoting motion that allows reducing this angle.

Thus, from FR 2 686 843 is known a device that mainly includes means defining a driving connection for causing a platform to slide and pivot with respect to a ramp and means capable of hinging said pivoting ramp with respect to said chassis at a location that allows making use of a rear overhang.

FR 2 682 336 also discloses another device of the same type, in which a worm driven by driving means allows achieving the moving of a platform with respect to a tilting chassis through a carriage fixed to the chain, movable in translation along said tilting chassis, and provided with fastening means that allow connecting it in a hinging way to the end of the platform.

These devices are however not fully satisfactory, because of the complexity of their structure, which not only weakens them and can quickly give rise to dysfunctions, but which, in addition, tend to substantially increase the cost of the trucks provided with them.

The aim of the present invention is to provide a transfer device with a cylinder of a simple design, which is reliable and inexpensive, capable of being used for moving a platform with respect to a ramp.

The transfer device with a cylinder for reversibly moving an object in horizontal or inclined translation over a travel distance substantially twice as large as that of said cylinder according to the invention is mainly characterised in that it includes a double-acting cylinder the rod of which includes, at its nd, means for returning by 180° on which symmetrically pass at least two cable elements, one for the extension and another one for the restoring, the latter being made integral by one end with the support of said cylinder and by the other end with said object, so that the outward movement of said rod causes said object to move in the same direction through the extending cable element, and also drives said restoring cable element, while the inward movement of said rod causes said object to move in the opposite direction through said restoring cable element and also drives said extending cable element.

By selecting the locations at which the ends of the cable elements are secured to the object and to the support of the cylinder, a travel distance of the object twice as large as that of the cylinder can be achieved in a way similar to the known effect used for a lifting truck and, according to the invention, the inward movement of the rod of the cylinder allows restoring the object through the restoring cable element.

According to a preferred embodiment of the device according to the invention, the cable elements consist of chains, whereas the returning means consist of pulleys mounted on a shaft arranged transversally to the end of the rod of the cylinder.

According to another additional feature of the device according to the invention, the shaft arranged transversally to the end of the rod of the cylinder is pivotally mounted on a movable bearing block slidably connected to the object.

Also according to the invention, the support consists of a ramp capable of tilting on the chassis of a vehicle through pivoting according to a transversal axis, whereas the object to be moved consists of a platform capable of sliding along said ramp.

According to another additional feature of the device according to the invention, the platform is slidably mounted on the ramp through at least one sliding block capable of sliding along said ramp and to which the outermost front portion of said platform is connected by means of a pivot with a transversal axis.

The advantages and the features of the device according to the invention will become clear when reading the following description, with reference to the attached drawing, which shows one non-restrictive embodiment.

In the attached drawing :

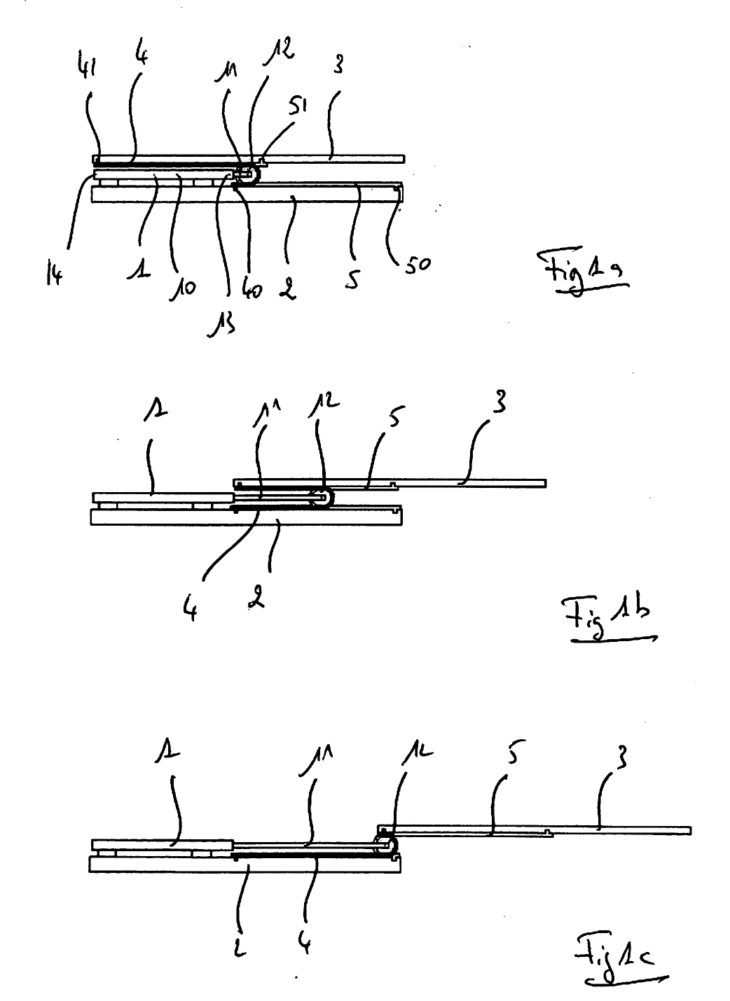

FIGS. 1a, 1b and 1c show schematic views of the transfer device with a cylinder according to the invention at various stages of its operation.

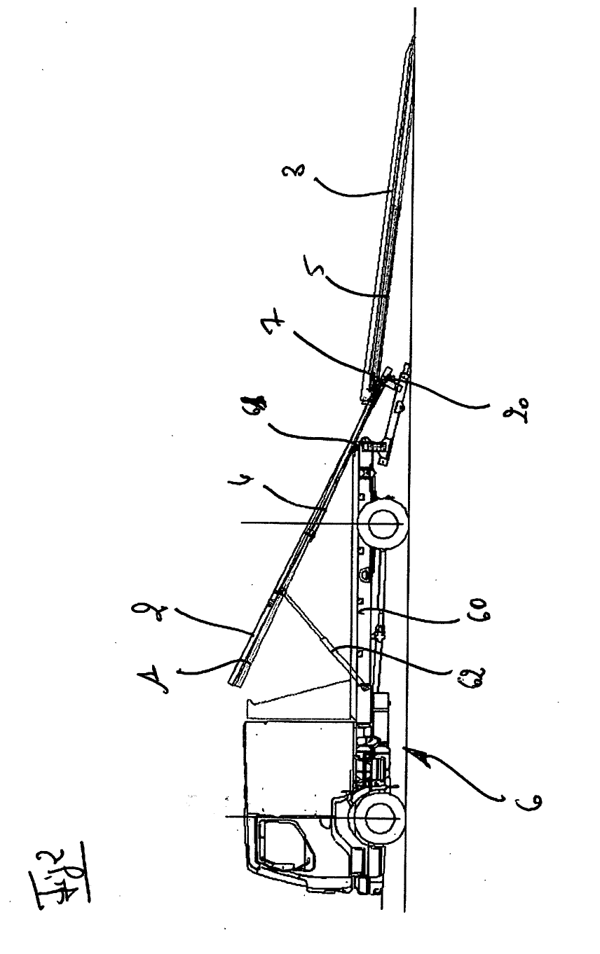

FIG. 2 shows a schematic side view of a vehicle provided with such a device.

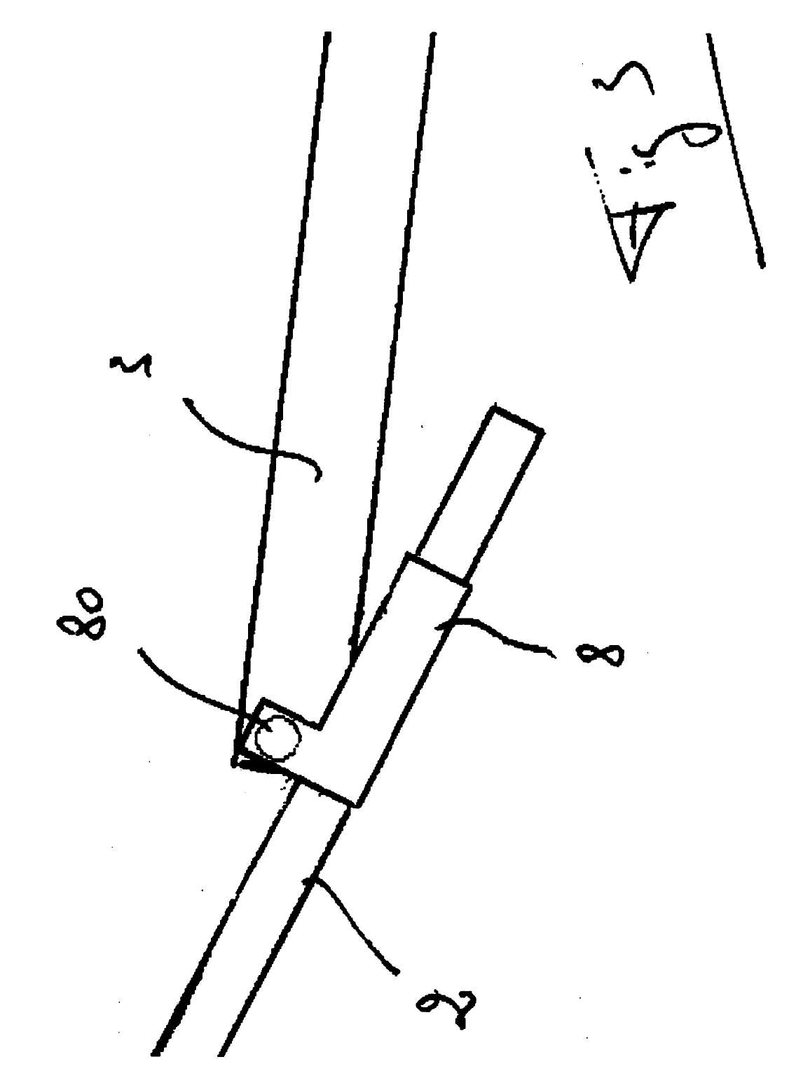

FIG. 3 shows a partial schematic view of a portion of this device.

When referring to figure 1a, which shows the transfer device with a cylinder according to the invention in resting position, one can see that the latter comprises a double-acting cylinder 1 borne by a support 2 and aimed at causing an object 3 to move.

The object 3 is slidably mounted, parallel to the support 2, directly on the latter or through means that are not shown.

The cylinder 1 includes a body 10 and a rod 11, the latter being provided, at its free end, with two pulleys or the like 12, only one of which can be seen in the figure, which are freely rotationally mounted according to a transversal axis.

Furthermore, the device comprises two cable elements 4 and 5, such as chains, made integral with both the support 2 and the object 3, and each passing over a pulley 12, to be returned by 180°.

Thus, the cable element 4, the so-called extending cable element, includes an end 40 made integral with the support 2 in the vicinity of the front end 13 of the body 10, whereas its other end 41 is made integral with the object 3 at some distance from the front end 13, in this case, in the resting position, in front of the rear end 14 of the body 10, so that the cable element extends along the body 10 and the object 3 over a length substantially equal to that of the body 10.

Likewise, the cable element 5, the so-called restoring cable element, includes an end 50 made integral with the support 2 at a location separated from the location of fastening of the end 40, whereas its other end 51 is made integral with the object 3 at a location separated from the location of fastening of the end 41, in this case, in resting position, at the level of the pulleys 12.

When referring now to FIGS. 1b and 1c, one can see that under the action of the outward movement of the rod 12 the cable element 4, due to the immobilisation of its end 40, slides on its pulley 12 and causes the object 3 to move, while the latter drives the end 51 of the cable element 5, which slides on its pulley 12.

When the rod 11 has fully moved out, as appears in FIG. 1c, it can be seen that the object 3 has travelled a distance twice as large as the travel distance of the cylinder 1.

One understands that the inward movement of the rod 11 results into pulling on the cable element 5, which, because of its end 50 being fastened to the support 2, causes the object 3 to move towards its resting position and, simultaneously, the cable element 4.

The cylinder 1 can thus cause an object to reversibly move horizontally, or according to a certain inclination, over a length reaching up to twice its travel distance.

One understands that for balance reasons, the cable elements 4 and 5 are preferably double and arranged symmetrically to the longitudinal axis of the aggregate.

The device according to the invention is particularly advantageous for transport vehicles with a moving platform, such as the one shown in FIG. 2.

This vehicle 6 includes a support 2 that consists of a ramp, whereas the object 3 consists of a platform. The platform 3 is capable of sliding on the ramp 2 under the action of a cylinder 1 integral with the ramp 2, and through extending 4 and restoring chains 5.

Advantageously, but not essentially, the end of the rod 11 of the cylinder 1 is connected, slidably in the longitudinal direction, to the platform 3, through a movable bearing block 7 that, in turn, bears the pulleys 12 through a shaft, not visible. The movable bearing block 7 thus allows supporting the end of the rod 11 of the cylinder 1.

Furthermore, the ramp 2 is connected in a hinging way to the chassis 60 of the vehicle 6, on a cross shaft 61 arranged at the rear end of the chassis 60, so that, under the action of a cylinder 62, the ramp 2 can tilt and its outermost rear cantilever portion 20 is lowered.

As can be seen in FIG. 3, the platform 3 is connected to the ramp 2 through side sliding blocks 8, only one of which can bee seen, each capable of sliding on an edge of the ramp 2, and each bearing a pivot 80 with a transversal axis allowing connecting the platform 3 at the level of the front end 30 of the latter, the front end 30 being the one opposite the rear end aimed at resting on the ground.

The sliding blocks 8 allow ensuring the guiding of the platform 3 during its sliding along the ramp 2, and the connection through the pivots 80 allows, during the lowering of the rear portion 20 of the ramp 2, reducing the angle formed by the platform 3 with respect to the ground.

The transfer device with a cylinder according to the invention, applied to a transport vehicle with a moving platform, provides the latter with numerous advantages, compared to the existing similar vehicles, the primary one of which is the simplicity of its design and, hence, of its manufacturing.

The platform 3 can indeed be unfolded and brought back onto the vehicle 6 under the only action of the cylinder 1 and, secondarily of the cylinder 62, whereas the connection through the sliding blocks 8 is of a very simple design and authorises an important lowering of the platform 3.

It is obvious that the present invention cannot be limited to the preceding description of one of its embodiments, which is likely to undergo some changes without therefore departing from the spirit of the invention.

1. Transfer device with a cylinder for reversibly moving an object (3) in horizontal or inclined translation over a travel distance substantially twice as large as that of said cylinder (1), characterised in that it includes a double-acting cylinder (1) the rod (11) of which includes, at its end, means for returning by 180° (12) on which symmetrically pass at least two cable elements, one for the extension (4) and another one for the restoring (5), the latter being made integral by one end (40, 50) with the support (2) of said cylinder (1) and by the other end (41, 51) with said object (3), so that the outward movement of said rod (11) causes said object (3) to move in the same direction through the extending cable element (4), and also drives said restoring cable element (5), while the inward movement of said rod (11) causes said object (3) to move in the opposite direction through said restoring cable element (5) and also drives said extending cable element (4).

2. Device according to claim 1, characterised in that the cable elements (4, 5) consist of chains, whereas the returning means (12) consist of pulleys mounted on a shaft arranged transversally to the end of the rod (11) of the cylinder (1).

3. Device according to claim 2, characterised in that the shaft arranged transversally to the end of the rod (11) of the cylinder (1) is pivotally mounted on a movable bearing block (7) slidably connected to the object (3).

4. Device according to any of the preceding claims, characterised in that the support consists of a ramp (2) capable of tilting on the chassis (60) of a vehicle (6), whereas the object to be moved consists of a platform (3) capable of sliding along said ramp (2).

5. Device according to claim 4, characterised in that the platform (3) is slidably mounted on the ramp (2) through at least one sliding block (8) capable of sliding along said ramp and to which the outermost front portion (30) of said platform (3) is connected by means of a pivot (80) with a transversal axis, whereas said ramp (2) is mounted on the chassis (60) in a tilting way about a transversal axis (61) and under the action of a cylinder (62).

6. Device according to claim 5, characterised in that it includes two sliding blocks (8), each of which is slidably mounted on a side of the ramp (2), and bears a pivot for connection to the platform (3).
